(19) United States
(12) Patent Application Publication
(10) Pub. No.: US 2018/0072340 A1
(43) Pub. Date: Mar. 15, 2018

(54) LEVER ASSEMBLY FOR CONTROLLING A LOCK OF A STEERING COLUMN ASSEMBLY AND METHOD OF MANUFACTURING

(71) Applicant: STEERING SOLUTIONS IP HOLDING CORPORATION, Saginaw, MI (US)

(72) Inventor: Joseph R. Streng, Freeland, MI (US)

(21) Appl. No.: 15/266,394

(22) Filed: Sep. 15, 2016

(51) Int. Cl. B62D 1/184; B62D 1/185; B62D 1/187

(52) U.S. Cl. CPC B62D 1/184; B62D 1/187; B62D 1/185

(57) ABSTRACT

A lever assembly for controlling a lock of a steering column assembly includes a lever body extending from a first end to a second end. Also included is a pivot portion integrally formed with the lever body and disposed at the second end of the lever body, the pivot portion defining a hollow portion and pivotable about an axis. Further included is an insert disposed within the hollow portion of the pivot portion and rotatable about the axis, the insert defining a receiving feature for receiving a fuse extending from the pivot portion, the fuse breaking upon application of a load that exceeds a predetermined load.

### BACKGROUND

The embodiments described herein relate to vehicle steering systems and, more particularly, to a lever assembly for controlling a lock of a steering column assembly, as well as a method of manufacturing such lever assemblies.

Many automotive steering columns provide a system for adjustment, such as vertical tilting and horizontal telescoping, for example. It is common for the adjustment mechanism to include a lever that can be manipulated by an operator to lock and unlock the mechanism. The lever location is placed with ergonomics in mind so it is easily within reach of the operator. This often places the lever in an area that may make the operator's knee vulnerable to hitting the lever, such as in a collision event of the vehicle. It is challenging to design the lever such that it is in a good ergonomic location while protecting the operator's knees in a collision event.

Prior efforts to address the above-noted issues include levers that have a “breakaway” or a “fused” feature that will provide sufficient resistance for normal lever operation, but still providing giving way at a prescribed safe load when struck by an object, such as a knee. These “fuse” features are typically integrated into the lever handle as a hole or notch to initiate the break location at a location that will not be visible during normal operation. The feature must also include a “tethering” function to prevent the lever from becoming a loose projectile after it has broken. This is typically performed with a separate strap or a wire component that adds cost and complexity. Although the integrated “fused” feature is designed to limit the break load for crash, it provides a challenge in satisfying a lever stiffness requirement that is important to most automotive manufacturers.

### SUMMARY

According to one aspect of the disclosure, a lever assembly for controlling a lock of a steering column assembly includes a lever body extending from a first end to a second end. Also included is a pivot portion integrally formed with the lever body and disposed at the second end of the lever body, the pivot portion defining a hollow portion and pivotable about an axis. Further included is an insert disposed within the hollow portion of the pivot portion and rotatable about the axis, the insert defining a receiving feature for receiving a fuse extending from the pivot portion, the fuse breaking upon application of a load that exceeds a predetermined load.

According to another aspect of the disclosure, a lever assembly for controlling a lock of a steering column assembly, the lever assembly includes a lever body extending from a first end to a second end. Also included is a pivot portion formed with the lever body and disposed at the second end of the lever body, the pivot portion defining a hollow portion and pivotable about an axis. Further included is a fuse disposed within the hollow portion of the pivot portion, the fuse breaking upon application of a load that exceeds a predetermined load.

According to yet another aspect of the disclosure, a steering column assembly includes a steering shaft. Also included is a collar. Further included is a steering column jacket that supports the steering shaft and is biased between a locked and unlocked position to lock and unlock movement between the steering column jacket and the collar. Yet further included is a lock assembly for adjusting movement of the steering column jacket. Also included is a lever assembly for controlling the lock assembly. The lever assembly includes a lever body extending from a first end to a second end, the lever body formed of plastic. The lever assembly also includes a pivot portion integrally formed with the lever body and disposed at the second end of the lever body, the pivot portion defining a hollow portion and pivotable about an axis, the pivot portion formed of plastic. The lever assembly further includes an insert disposed within the hollow portion of the pivot portion and rotatable about the axis, the insert defining a notch for receiving a fuse extending from the pivot portion, the fuse breaking upon application of a load that exceeds a predetermined load, the insert formed of metal.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a lock portion of a steering column assembly;

FIG. 2 is a perspective view of a lever assembly of the steering column assembly;

FIG. 3 is a perspective view of the lever assembly with a portion of the lever assembly shown transparently;

FIG. 4 is an elevation view of the lever assembly; and

FIG. 5 is an enlarged view of a pivot portion and insert of the lever assembly.

### DETAILED DESCRIPTION

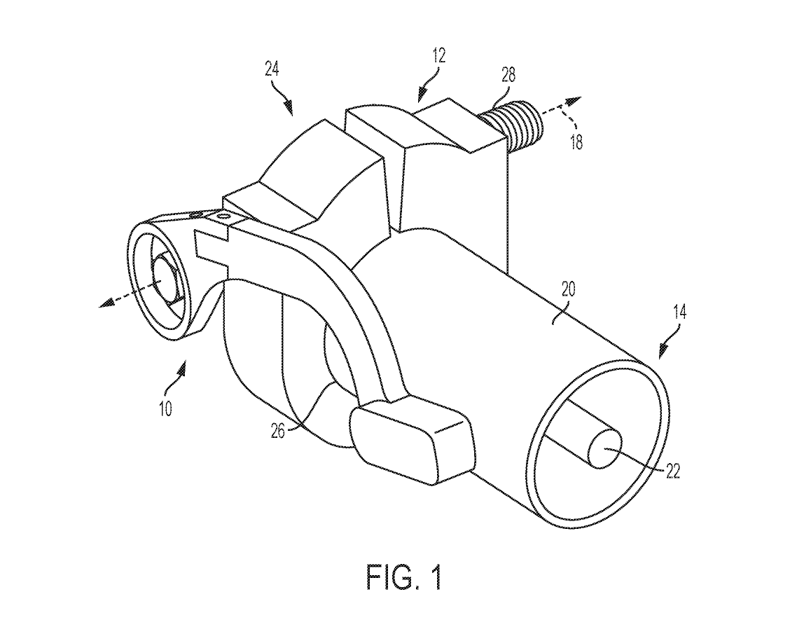

Referring now to the Figures, where the invention will be described with reference to specific embodiments, without limiting same, FIG. 1 illustrates a lever assembly 10 for controlling a lock 12 of a steering column assembly 14. The lever assembly 10 is pivotable about a locking axis 18 between a locked position for substantially preventing adjusting movement of the steering column assembly 14 and an unlocked position spaced from the locked position. The steering column assembly 14 is moveable in adjusting movement when the lever assembly 10 is in the unlocked position.

In the illustrated embodiment, the steering column assembly 14 includes a steering column jacket 20 operable to support a steering shaft 22 in a vehicle. A steering wheel (not shown) can be engaged at one end of the steering shaft 22. A collar 24 presents a surface 26 for guiding movement of the steering column jacket 20. The collar 24 can guide sliding movement of the steering column jacket 20, corresponding to telescoping movement, or can guide raking movement of the steering column jacket 20 in some embodiments. Also, in some embodiments, the collar 24 can be integrally formed with a first steering column jacket and guide movement of a second steering column jacket.

The lock 12 includes a locking member 28 operable to move in a first direction from an unlocked position to a locked position to increasingly urge the steering column jacket 20 and the surface 26 together to lock relative movement between the steering column jacket 20 and the collar 24.

The illustrated lock 12 and the steering column assembly 14 are merely illustrative. In alternative embodiments, different locking structures can be employed, such as wedge locks, positive locks with detents and/or teeth, or electro-mechanical locks. Also, any configuration of steering column assembly 14 can be used, including telescoping columns, raking columns, tilting columns, and any combination of telescoping, raking and tilting columns.

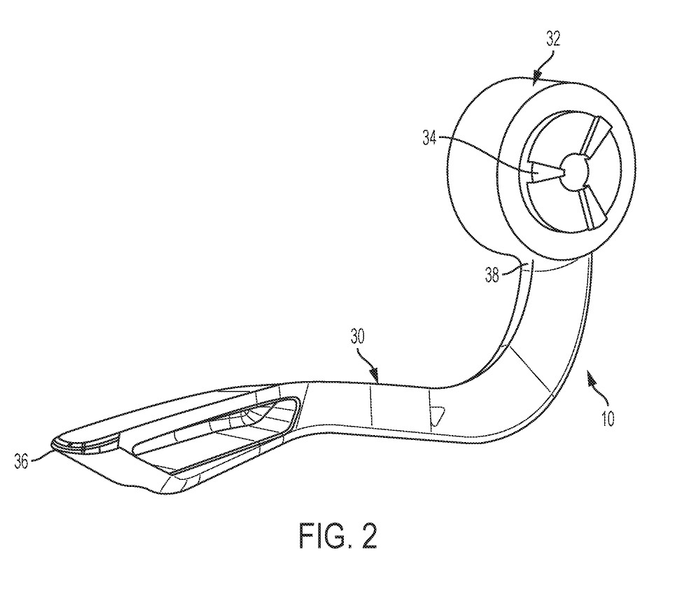

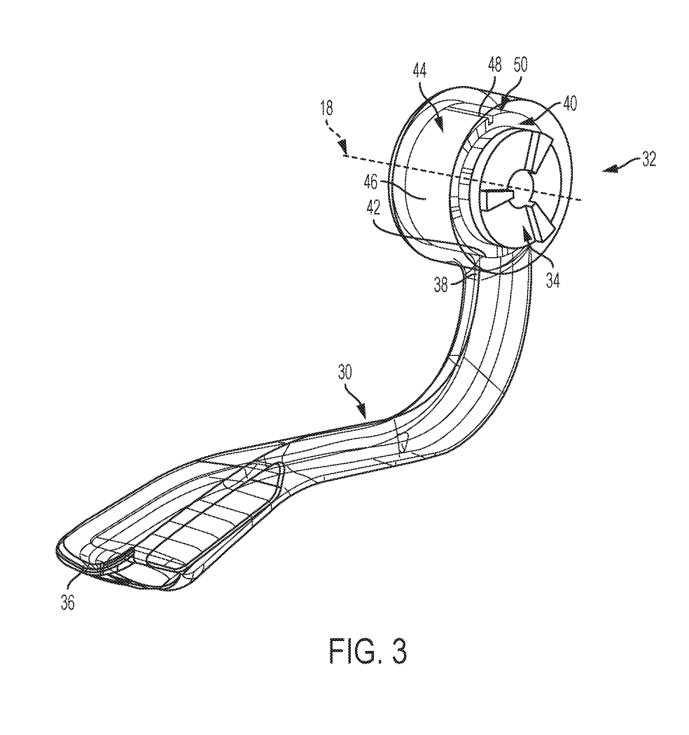

Referring now to FIGS. 2 and 3, regardless of the type of lock 12 and steering column assembly 14, the lever assembly 10 is employed to control the locking operations described above. The lever assembly 10 includes a lever body 30, a pivot portion 32 and an insert 34. The lever body 30 extends from a first end 36 to a second end 38. The lever body 30 may extend between the ends 36, 38 with numerous contemplated contours that are commonly present in handle portions of such levers.

The lever body 30 and the pivot portion 32 are integrally formed, with the pivot portion 32 disposed at the second end 38 of the lever body 30. The pivot portion 32 is pivotable about the locking axis 18 to facilitate locking and unlocking of the lock 12. Application of a force by a user up to a predetermined load is considered normal operation of the lever assembly 10 and allows transitioning between the locked and unlocked conditions of the steering column assembly 14 for adjustment thereof. The predetermined load will vary depending upon the particular application.

The pivot portion 32 defines a hollow portion 40 with an inner surface 42 of the pivot portion 32. As shown in the illustrated embodiment, the inner surface 42 is a cylindrical inner surface defining a cylindrical hollow portion. Such a geometric configuration permits a cylindrical portion 44 of the insert 34 to be disposed within the hollow portion 40 of the pivot portion 32. The cylindrical portion 44 of the insert 34 is defined by a first circumferential wall 46 that is dimensioned to be fittingly disposed within the hollow portion 40. It is contemplated that contact between the first circumferential wall 46 of the insert 34 and the inner surface 42 of the pivot portion 32 is present. It is further contemplated that a clearance between these surfaces is present.

The insert 34 is pivotable about the locking axis 18. The insert 34 pivots with the lever body 30 and the pivot portion 32 upon the application of a force on the lever body 30 up to a predetermined load. The coordinated rotation up to the predetermined load is facilitated by a fused relationship comprising a fuse 48 extending radially inwardly from the inner surface 42 of the pivot portion 32 and into a receiving feature 50 defined by the insert 34. In some embodiments, the receiving feature 50 is a notch, recess, or the like extending radially inwardly from the first circumferential wall 46. Disposal of the fuse 48 within the receiving feature prevents relative rotation between the pivot portion 32 and the insert 34 when the predetermined load is not exceeded, thereby allowing normal operation of the lever assembly 10.

The fuse 48 and the insert 34 are formed of respective materials that are sufficiently rigid to retain the fuse 48 within the receiving feature 50 during normal operation of the lever assembly 10. However, the respective materials also facilitate breaking of the fuse 48 if the load applied to the lever body 30 exceeds the predetermined load. The predetermined load is exceeded when an abnormal load is applied, such as an operator's knee during a collision event. In some embodiments, the fuse 48 is formed of plastic and the insert 34 is formed of metal. The fuse 48 may be a single, integrally formed component with the lever body 30 and the pivot portion 32. For example, the lever body 30, the pivot portion 32 and the fuse 48 may be over-molded over the insert 34. Alternatively, the fuse 48 may be injection molded subsequent to disposing the insert 34 within the hollow portion 40 of the pivot portion 32 in a manner that completely or substantially fills the receiving feature 50. An injection process may be beneficial if the remainder of the lever is not formed of a material that is conducive to breakaway loads.

By locating the fused feature of the components at the end of the lever, and not at an intermediate location, the strength of the breakaway feature may be customized independently of the stiffness of the lever. Decoupling these design considerations provides enhanced flexibility.

Upon breaking of the fuse 48, the corresponding cylindrical surfaces of the inner surface 42 of the pivot portion 32 and the first circumferential wall 46 of the insert 34 allows the lever body 30 and pivot portion 32 to rotate relative to the insert 34. During the relative rotation, the insert 34 remains grounded and retains the lever body 30 and the pivot portion 32, thereby preventing the components from breaking loose of the insert 34. This eliminates the need for a “tether” feature that is required in other designs to prevent detachment of a portion of the lever.

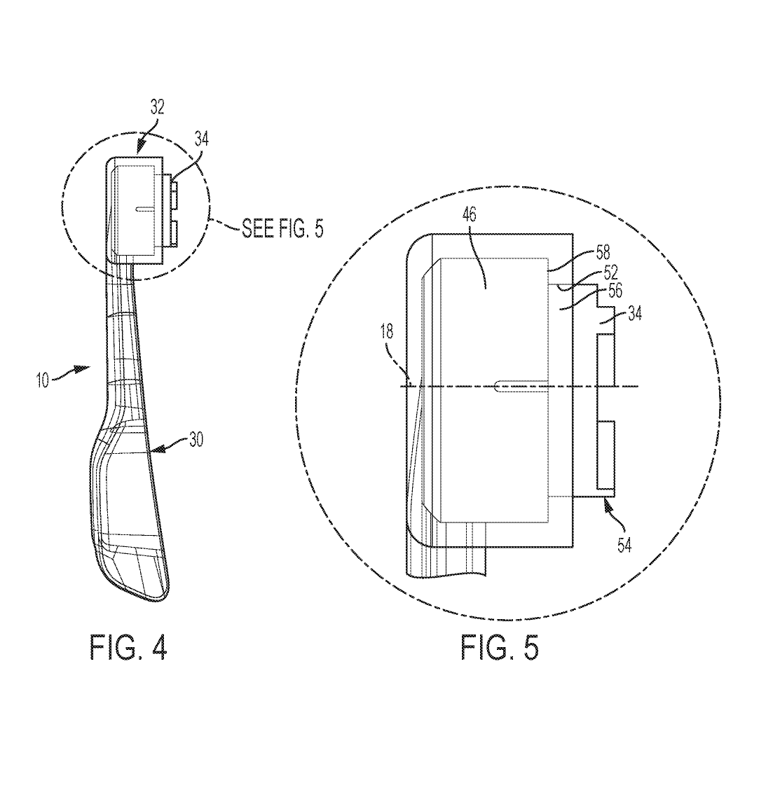

Referring now to FIGS. 4 and 5, an aperture of the pivot portion 32 is defined by an aperture wall 52 that allows a portion of the insert 34 to project therethrough. In particular, a protruding portion 54 of the insert 34 protrudes through the aperture, with a second circumferential wall 56 of the insert 34 fitting within the aperture wall 52. The second circumferential wall 56 has a circumference that is less than the circumference of the first circumferential wall 46 and a shoulder wall 58 connects the circumferential walls 46, 56. The shoulder wall is oriented at an angle, such as perpendicular to the circumferential walls 46, 56 to prevent withdrawal of the insert 34 from the hollow portion 40 of the pivot portion 32.

Advantageously, the lever assembly 10 described herein allows for a robust lever geometry so stiffness and strength functions can be decoupled from the breakaway function described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A lever assembly for controlling a lock of a steering column assembly, the lever assembly comprising:
a lever body extending from a first end to a second end;
a pivot portion integrally formed with the lever body and disposed at the second end of the lever body, the pivot portion defining a hollow portion and pivotable about an axis, the hollow portion defined by an inner surface of the pivot portion;
a fuse formed with the inner surface and extending radially inwardly therefrom; and
an insert disposed within the hollow portion of the pivot portion and rotatable about the axis, the insert defining a receiving feature for receiving the fuse extending from the pivot portion, the fuse breaking upon application of a load that exceeds a predetermined load.

2. The lever assembly of claim 1, wherein the lever body and pivot portion are each formed of plastic and the insert is formed of metal.

3. The lever assembly of claim 1, wherein the hollow portion is a cylindrical hollow portion and the inner surface is a cylindrical inner surface, the insert being cylindrical with a first circumferential wall fitting within the cylindrical surface.

4. The lever assembly of claim 3, wherein the receiving feature is disposed along the first circumferential wall of the insert.

5. The lever assembly of claim 4, wherein the receiving feature is a notch.

6. The lever assembly of claim 1, wherein the pivot portion defines an aperture with an aperture wall, the insert having a protruding portion protruding through the aperture, the protruding portion having a second circumferential wall fitting within the aperture wall, the first circumferential wall and the second circumferential wall connected with a shoulder wall.

7. The lever assembly of claim 6, wherein the shoulder wall is oriented perpendicular to the first and second circumferential walls.

8. The lever assembly of claim 1, wherein disposal of the fuse within the receiving feature prevents relative rotation between the pivot portion and the insert when the predetermined load is not exceeded.

9. A lever assembly for controlling a lock of a steering column assembly, the lever assembly comprising:
a lever body extending from a first end to a second end;
a pivot portion formed with the lever body and disposed at the second end of the lever body, the pivot portion defining a hollow portion and pivotable about an axis, the hollow portion defined by an inner surface of the pivot portion; and
a fuse disposed within the hollow portion of the pivot portion and formed with the inner surface and extending radially inwardly therefrom, the fuse breaking upon application of a load that exceeds a predetermined load.

10. The lever assembly of claim 9, wherein the lever body and pivot portion are each formed of plastic.

11. The lever assembly of claim 9, wherein the hollow portion is a cylindrical hollow portion and the inner surface is a cylindrical inner surface, wherein an insert is disposed within the hollow portion and receives the fuse therein.

12. The lever assembly of claim 11, wherein the pivot portion defines an aperture with an aperture wall, the insert having a protruding portion protruding through the aperture, the protruding portion having a circumferential wall fitting within the aperture wall.

13. A steering column assembly comprising:
a steering shaft;
a collar;
a steering column jacket that supports the steering shaft and is biased between a locked and unlocked position to lock and unlock movement between the steering column jacket and the collar;
a lock assembly for adjusting movement of the steering column jacket; and
a lever assembly for controlling the lock assembly, the lever assembly comprising:
a lever body extending from a first end to a second end;
a pivot portion integrally formed with the lever body and disposed at the second end of the lever body, the pivot portion defining a hollow portion and pivotable about an axis, the pivot portion formed of plastic, the hollow portion defined by a inner surface of the pivot portion;
a fuse formed with the inner surface and extending radially inwardly therefrom; and
an insert disposed within the hollow portion of the pivot portion and rotatable about the axis, the insert defining a notch for receiving the fuse, the fuse breaking upon application of a load that exceeds a predetermined load, the insert formed of metal.

14. The steering column assembly of claim 13, wherein the hollow portion is a cylindrical hollow portion and the inner surface is a cylindrical inner surface, the insert being cylindrical with a first circumferential wall fitting within the cylindrical surface.

15. The steering column assembly of claim 13, wherein the pivot portion defines an aperture with an aperture wall, the insert having a protruding portion protruding through the aperture, the protruding portion having a second circumferential wall fitting within the aperture wall, the first circumferential wall and the second circumferential wall connected with a shoulder wall.

16. The steering column assembly of claim 15, wherein the shoulder wall is oriented perpendicular to the first and second circumferential walls.

17. The steering column assembly of claim 13, wherein disposal of the fuse within the notch prevents relative rotation between the pivot portion and the insert when the predetermined load is not exceeded.
